(19) United States
(12) Patent Application Publication
(10) Pub. No.: US 2026/0052096 A1
(43) Pub. Date: Feb. 19, 2026

(54) Cognition-Compatible Network Substrate and Memory-Native Protocol Stack

(71) Applicant: Nicholas Clark, Thetford Center, VT (US)

(72) Inventor: Nicholas Clark, Thetford Center, VT (US)

(21) Appl. No.: 19/366,760

(22) Filed: Oct. 23, 2025

Related U.S. Application Data
(60) Provisional application No. 63/726,519, filed on Nov. 30, 2024.
(60) Provisional application No. 63/787,082, filed on Apr. 11, 2025.
(60) Provisional application No. 63/789,967, filed on Apr. 16, 2025.
(60) Provisional application No. 63/800,515, filed on May 6, 2025.

(51) Int. Cl. H04L 45/00; H04L 69/22

(52) U.S. Cl. CPC H04L 45/22; H04L 69/22

(57) ABSTRACT

A computer-implemented system and method for distributed memory-native networking using agents. Each agent comprises a unique identifier, payload, memory field containing lineage and policy references, transport metadata, and a cryptographic signature. A modular protocol stack processes these agents through routing, indexing, and consensus layers, with behavior determined by embedded memory. Routing decisions are trust-scoped based on memory-derived access logs and health feedback. Mutation proposals are validated using dynamic, memory-referenced quorum formation. The system enables stateful, policy-bound propagation, structural reorganization, and adaptive execution without centralized coordination or persistent session state. It operates over conventional transport protocols and supports interoperability with cognition-layer payloads, including semantic execution. The architecture allows dynamic trust modeling, autonomous network adaptation, and memory-driven mutation governance across heterogeneous, decentralized, and high-latency environments.

### RELATED APPLICATION DATA

This application claims the benefit of priority of U.S. Provisional Patent Application Ser. No. 63/726,519, filed on Nov. 30, 2024, titled “Adaptive Network Framework (ANF) for Modular, Dynamic, and Decentralized systems”, U.S. Provisional Application Ser. No. 63/787,082, filed on Apr. 11, 2025, titled “AQ (Adaptive Query): A Programming Language and Cognitive Execution Layer for Distributed, Stateful AI”, U.S. Provisional Application Ser. No. 63/789,967, filed on Apr. 16, 2025, titled “Cross-Domain Applications of the Adaptive Query Framework”, U.S. Provisional Patent Application Ser. No. 63/800,515, filed on May 6, 2025, titled “Cognition-Native Semantic Execution Platform for Distributed, Stateful, and Ethically-Constrained Agent Systems”, each of which is incorporated by reference herein in its entirety.

### FIELD

The present disclosure generally relates to distributed computing systems and network protocols. In particular, the present disclosure is directed to a cognition-compatible network substrate, memory-native protocol stack and systems and methods thereof.

### BACKGROUND

Conventional network architectures, including TCP/IP, DNS, REST APIs, and content distribution networks, are designed for stateless packet transmission, treating data as transient and relying on external layers for session continuity, trust evaluation, and policy enforcement. Routing and indexing systems in these architectures are typically centralized, static, and address-based, limiting their ability to support adaptive behavior, decentralized trust management, or dynamic semantic coordination. As distributed systems evolve to require greater autonomy, semantic awareness, and policy-driven mutation control—particularly in domains such as decentralized artificial intelligence, federated knowledge networks, Internet of Things (IoT), and interplanetary communication—existing architectures impose significant constraints. Accordingly, there is a need for systems and methods that address these shortcomings.

### SUMMARY OF THE DISCLOSURE

A computer-implemented system for memory-native protocol execution having a plurality of agents, wherein each of the plurality of agents includes a unique identifier, a payload, a memory field, a transport header, and a cryptographic signature, a plurality of distributed nodes, wherein each of the plurality of distributed nodes is configured to transmit and receive any of the plurality of agents, and a modular protocol stack, wherein the modular protocol stack is configured to be executed at each of the plurality of distributed nodes, and wherein the modular protocol stack includes a routing layer, an indexing layer, and a consensus layer. Behavior within the system of the routing layer, the indexing layer, and the consensus layer is determined by metadata embedded within a received respective one of the plurality of agents. The memory field of each of the plurality of agents includes verifiable lineage, access logs, and policy references, and the verifiable lineage, the access logs, and the policy references include sets of instructions configured to govern routing, mutation, and consensus behavior for the corresponding one of the plurality of agents.

A computer-implemented method for distributed memory-native communication that includes receiving an agent at a node, the agent comprising a unique identifier, an access log, a payload, a memory field, a transport header, and a signature, verifying the signature of the agent and parsing the transport header and the memory field, determining routing eligibility and mutation scope of the agent by evaluating the access log and policy references of the agent, executing one or more protocol stack layers based on content contained in the memory field, appending a trace log to the memory field, and forwarding, after appending the trace log, the agent to one or more eligible nodes, wherein the one or more eligible nodes is determined by assessing dynamic routing protocol and one or more memory field constraints, for mutation execution or resolution.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 schematically depicts a distributed, trust-scoped execution network exchanging agents across heterogeneous nodes in accordance with an embodiment of the present disclosure;

FIG. 2 is a schematic overview of an internal structure of an agent, including its UID, semantic payload, transport header, append-only memory field, and cryptographic signature in accordance with an embodiment of the present disclosure;

FIG. 3 is a schematic depiction of a layered execution stack that may be used to process agents in accordance with an embodiment of the present disclosure;

FIG. 4 illustrates a network routing layer and a process for evaluating candidates based on agent access logs, trust graph history, policy alignment, and network health feedback in accordance with an embodiment of the present disclosure;

FIGS. 5A and 5B outlines processes for entropy-triggered semantic index restructuring in accordance with an embodiment of the present disclosure;

FIG. 6 outlines a technique for processing a mutation proposal through trust-weighted voting by a governance layer in accordance with an embodiment of the present disclosure;

FIG. 7 is a schematic diagram depicting an exemplary process by which incoming health agents from trusted nodes influence protocol behavior;

FIG. 8 is a schematic depiction of agent routing among candidate nodes, in which selection is based on memory-derived trust scores in accordance with an embodiment of the present disclosure;

FIG. 9 illustrates schematically a system and process for alias resolution and access validation in accordance with an embodiment of the present disclosure; and

FIGS. 10A and 10B are map-style views of a federated network that includes semantic zones, trust boundaries, node stack capabilities, and agent routing paths in accordance with an embodiment of the present disclosure.

### DETAILED DESCRIPTION

### 1. Overview

Current systems are not optimized for embedding memory or governance context within the data itself, nor for supporting runtime mutation validation, adaptive routing based on trust, or semantic self-restructuring. A network substrate is disclosed in which the primary unit of protocol execution is a memory-bearing agent. Unlike conventional network architectures, which treat data packets as stateless and transient, this system embeds persistent, verifiable memory directly within each object, enabling the network to operate as a stateful, protocol-native computation substrate. Each agent comprises a unique identifier, a payload, a memory field containing lineage and access history, a transport header encoding delivery constraints, and a cryptographic signature. These agents do not merely carry data; they govern their own routing, mutation eligibility, and consensus behavior based on their accumulated memory and embedded policy references.

The network substrate operates through a horizontally composable protocol stack that may include routing, indexing, caching, and consensus layers. Each layer is memory-aware and interprets the agent deterministically, based on local context and verifiable agent-resident state. No reliance on external session management, centralized controllers, or pre-configured address registries is required. Instead, emergent behavior arises from the interaction of memory-bearing agents and deterministic, composable protocols.

This memory-native approach enables the substrate to support semantic evolution, context-sensitive routing, dynamic mutation validation, and behaviorally scoped access control across asynchronous, disconnected, or federated environments. The substrate may be implemented atop legacy transport layers including TCP/IP, HTTP, WebRTC, or delay-tolerant mesh architectures, and may be deployed incrementally in environments ranging from edge devices to interplanetary networks. While the system may integrate with structurally governed containers such as adaptive indexes or cognition-layer semantic agents, it functions independently of any specific structural or cognitive framework. This allows for deployment as a general-purpose execution and communication substrate for any environment requiring verifiable state continuity, adaptive routing, or semantic governance at the protocol level.

In systems where cognition-compatible execution layers are implemented above this substrate, such as those described in U.S. Nonprovisional Ser. No. 17/888,001 , titled “Cognition-Native Semantic Execution Platform for Distributed, Stateful, and Ethically-Constrained Agent Systems,” filed Jun. 6, 2025 and incorporated by reference for that subject matter, the platform can support the propagation of persistent semantic agents that perform long-horizon reasoning tasks, including memory-resident adaptive queries that evolve across decentralized environments.

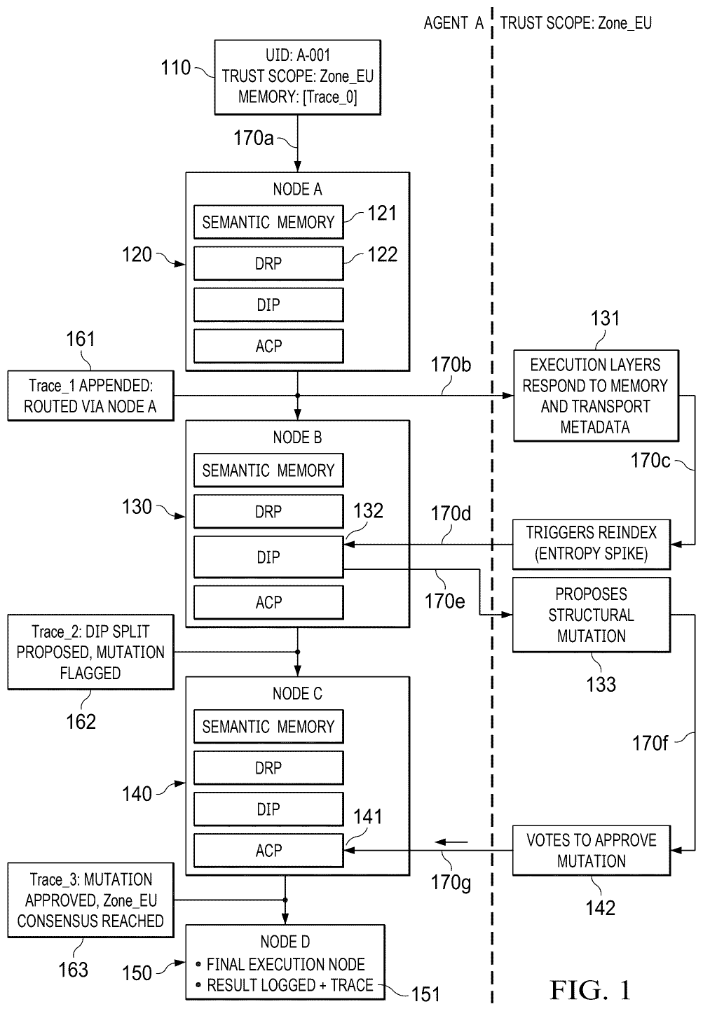

FIG. 1 illustrates a cognition-compatible execution network comprising multiple distributed nodes exchanging memory-bearing agents over a modular protocol stack. At a first stage, an agent A (110) is instantiated with a unique identifier (UID: A-001), trust scope metadata (e.g., Zone_EU), and an initial memory trace (Trace_0). The agent enters Node A (120), which performs an initial read of the embedded memory field (121) to retrieve execution lineage and trust scope parameters. Based on these parameters, Node A uses a dynamic routing protocol (DRP, 122) to compute route scoring using trust-weighted evaluation logic and forwards the agent to the next optimal node.

At Node B (130), the execution layers respond to memory and transport metadata (131) as a semantic divergence is detected—manifested as an entropy spike in the agent's contextual signal. In response, the dynamic indexing protocol (DIP, 132) within Node B triggers a reindexing operation and proposes a structural mutation (133) to the agent's schema. This mutation is appended as a provisional memory update and marked with a flag indicating pending consensus validation. The agent is routed to Node C (140), a designated consensus node.

At Node C, the mutation proposal 133 is evaluated against local policy constraints and memory-scoped quorum rules. Using an adaptive consensus protocol (ACP, 141), Node C issues a consensus response to the mutation proposal (142) based on trust-weighted policy evaluation, appending an execution trace that records quorum participation, mutation type, and consensus result. The agent may spawn child agents that are routed to participating nodes to achieve quorum. Upon achieving quorum—based on trust-weighted votes collected from participating nodes—the updated agent, including its modified structure and accumulated trace, is propagated to Node D (150), the final execution node.

Node D finalizes the mutation execution by committing the approved structural changes to the agent's memory field, logging the result locally, and appending a terminal trace entry (151) confirming successful propagation. The agent now includes a complete memory lineage across the trust-scoped execution path: The agent may spawn child agents that are routed to participating nodes to update index maps.

Trace_1 (161) denotes successful routing via Node A; Trace_2 (162) logs the mutation proposal and entropy signal at Node B; and Trace_3 (163) records consensus approval at Node C. Each node interacts with the agent through a layered protocol interface encompassing routing, indexing, and consensus, and a semantic memory interpreter. Arrows 170a-170g indicate protocol-executed process flows rather than direct hardware links. The system operates without centralized orchestration, relying instead on embedded memory, cryptographically validated policy references, and trust-scoped semantic coordination.

The network substrate is cognition-compatible not because it performs cognition, but because it retains state, interprets accumulated experience, and enables dynamic, policy-governed behavior at runtime. It supports systems that learn, restructure, and adapt—not through AI models, but through memory continuity and protocol determinism embedded in the data itself.

### 2. Agent Structure and Role in Protocol Execution

In the disclosed system, the agent is the unit of transmission, execution, and memory continuity. Unlike traditional network packets or opaque payload objects, each agent in this architecture is a cryptographically self-contained operand. Its structure includes a unique identifier (UID), a semantic payload, a transport header, a memory field, and a digital signature. These fields are not merely metadata—they govern the behavior of the protocol stack as the agent traverses a distributed network of nodes.

The UID allows each agent to be tracked across its lifecycle and ensures uniqueness within the substrate. The payload may contain arbitrary semantic data—such as executable code, structured knowledge, or query logic—and is interpreted according to the agent's declared semantic class and execution context. The transport header specifies routing and propagation constraints including time-to-live, trust radius, and scope-limited delivery paths. This allows for deterministic delivery behavior that aligns with system policies and network health conditions.

In addition, each agent includes a memory field. This field contains a signed lineage record, access logs, and references to policy agents that define permissions for mutation, routing, or consensus participation for the agent. The memory field also optionally includes trace outcomes, feedback signals, and prior decisions made during the agent's execution. This field enables the agent to carry its own history, behavioral context, and trust evaluation criteria into every node it contacts. As a result, the agent governs its own execution path without reliance on session tokens, external state stores, or centralized routing controllers.

The cryptographic signature ensures that any modification to the agent structure—including changes to the memory field—is verifiable. Each agent includes a digital signature computed over a canonical serialization of its UID, payload, memory field, and transport header, signed using the private key of the originating node. Upon receipt, the executing node re-serializes the agent content and validates the signature using the sender's public key. If validation fails, the agent is rejected by the protocol stack's validation layer, which discards the agent and logs the rejection outcome locally. This protects against mutation forgery, routing tampering, and unauthorized policy overrides.

By embedding governance logic directly into the data object, i.e., the agents, the agents become protocol-native carriers of executable context. Each layer of the protocol stack—whether routing, indexing, or consensus—consults the memory field before acting. The result is a network in which the data itself initiates and constrains its journey, enforcing trust alignment and behavioral determinism at runtime.

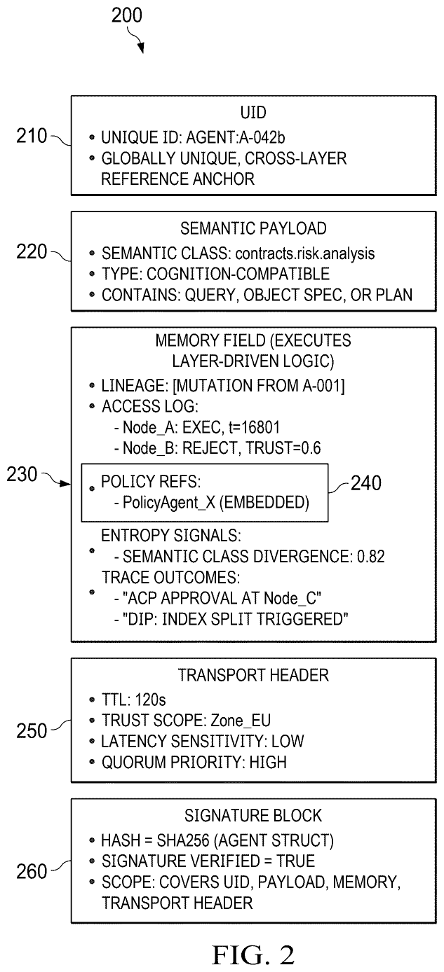

FIG. 2 illustrates an example of internal architecture of an agent 200 configured for cognition-native network execution. Agent 200 includes a globally unique identifier (UID 210) that anchors identity across memory, transport, and policy layers. The UID serves as the cryptographic root for mutation lineage, identity continuity, and execution traceability.

Attached to the UID is a semantic payload (220), which may contain intent statements, structured logic, object references, or planning directives. The payload is designed to be interpreted by distributed protocol layers and may evolve through mutation, refinement, or recursion in response to embedded memory and policy logic.

A memory field (230) is maintained as an append-only record of trace outcomes, access logs, entropy signals, and mutation lineage. Each entry in memory field 230 is signed by the contributing node and linked via hash chaining, enabling time-ordered auditability across trust zones. Adjacent to the memory field is a policy reference block (240), which encodes canonical references or embedded stubs to governing policy agents. These policies define access constraints, mutation eligibility, and role enforcement logic, and are validated at runtime via local or cached resolution.

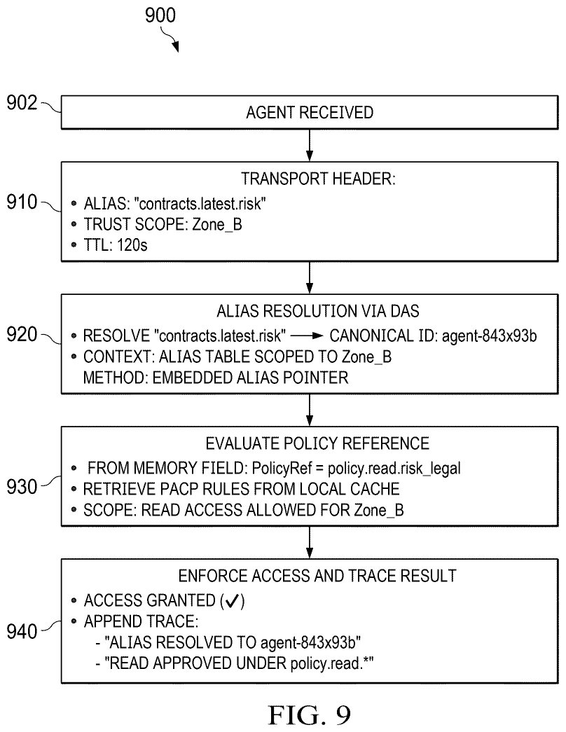

A transport header (250) encapsulates runtime metadata including trust scope, latency sensitivity, quorum priority, and alias identifiers, as outlined in process 900 in FIG. 9, when an agent is received at step 902 by the transport header (910) contains a semantic alias—such as “contracts.latest.risk” —this alias must be resolved to a canonical identifier using a dynamic alias system (DAS. 920). Resolution occurs against a zone-local alias table scoped to the agent's declared trust domain (e.g., Zone_B), using a pointer embedded in the transport field or memory reference.

Following alias resolution, the node retrieves a policy reference from the memory field—e.g., policy.read.risk_legal—and evaluates it using locally cached policy and access control protocol (PACP) rules (930). The result of this evaluation determines whether access, mutation, or routing is permitted under the current trust and context scope. Upon successful validation, the node appends a trace entry to the agent memory, recording the alias resolution result and policy enforcement decision (940).

To ensure semantic integrity, agent fields—such as UID, payload, memory, policy reference, and transport metadata—may be cryptographically hashed and signed into a scoped signature block (260). Signature validation occurs at each node to confirm authenticity, continuity, and semantic alignment before execution or propagation is permitted.

This architectural decision—treating data as a memory-bearing agent of protocol execution—enables the network to shift from packet-switched statelessness to cognition-compatible stateful behavior. The agent does not just carry information; it participates in its own delivery, mutation, and governance.

### 3. Memory Field Functionality and Semantic Context Awareness

The memory field within each agent functions as the persistent context layer through which the network infers, constrains, and governs behavior of the agents. This field contains cryptographically signed records representing the agent's mutation lineage, access log, and policy references. These records act as governing constraints that influence the agent's behavior during protocol execution. The memory field transforms each agent into a state-aware, context-bearing object capable of enforcing its own routing limits, execution eligibility, and mutation permissions.

The mutation lineage entry is a sequential record of structural changes the agent has undergone, including prior governing zones, proposed or accepted mutations, and their associated policy references. This lineage is used by consensus nodes to evaluate whether a proposed mutation is allowed under the currently active policy and whether the agent's current state is derivable from a trusted origin. This provides a substrate-level defense against unauthorized forking, out-of-scope overrides, or stale mutation replays.

The access log tracks node interactions, including read, write, and execution events, along with associated timestamps and trust metadata. This log enables routing decisions based on historical behavior. For instance, if a node repeatedly mishandles agents from a given semantic class, that pattern may be encoded into the trust model of future agents, allowing the routing layer to suppress or penalize propagation in that direction.

Policy references stored in the memory field point to specific policy agents—autonomous semantic objects that encode governance rules, mutation eligibility criteria, and quorum thresholds. These references may be resolved by alias (e.g., via the alias resolution systems and methods disclosed in U.S. patent application Ser. No. 19/326,036, titled “Adaptive Network Framework For Modular, Dynamic, and Decentralized Systems” filed Sep. 11, 2025, which is incorporated by reference for such disclosures) or embedded directly as canonical identifiers. The referenced policy agent specifies which entities may mutate the agent, what quorum structures must be satisfied, and which semantic behaviors are permitted during execution. This allows protocol layers, such as routing or consensus, to evaluate authority locally using only the agent's embedded memory, without requiring external session verification or off-chain lookup. The use of embedded policy also enables secure operation in disconnected or intermittently connected networks, such as IoT or interplanetary systems

Agents may also append semantic traces to the memory field as they traverse the network. These traces include both local decisions (e.g., routing outcomes or rejection causes) and network-wide feedback (e.g., system health, cache status, propagation entropy). Such data is referenced by other nodes to inform routing, consensus participation, and mutation priority.

As illustrated in FIG. 2, each agent 200 includes an append-only memory field (230) that governs how the agent is routed, validated, and mutated across distributed trust zones. The memory field contains a layered structure of execution traces, lineage entries, entropy signals, and policy references. These embedded elements inform behavior at multiple protocol layers—including trust-scoped routing decisions, semantic indexing, and quorum participation in consensus decisions.

Each memory trace captures the execution context of a prior node, including success or failure of mutation proposals, policy resolution outcomes, and semantic divergence events. Each trace entry is individually signed by the node that generated it, using that node's private key. These signatures ensure trace integrity and non-repudiation and are chained using cryptographic hashes to preserve both auditability and chronological ordering. In doing so, the memory field acts not merely as a static log, but as an active driver of semantic context, policy enforcement, and downstream decision-making.

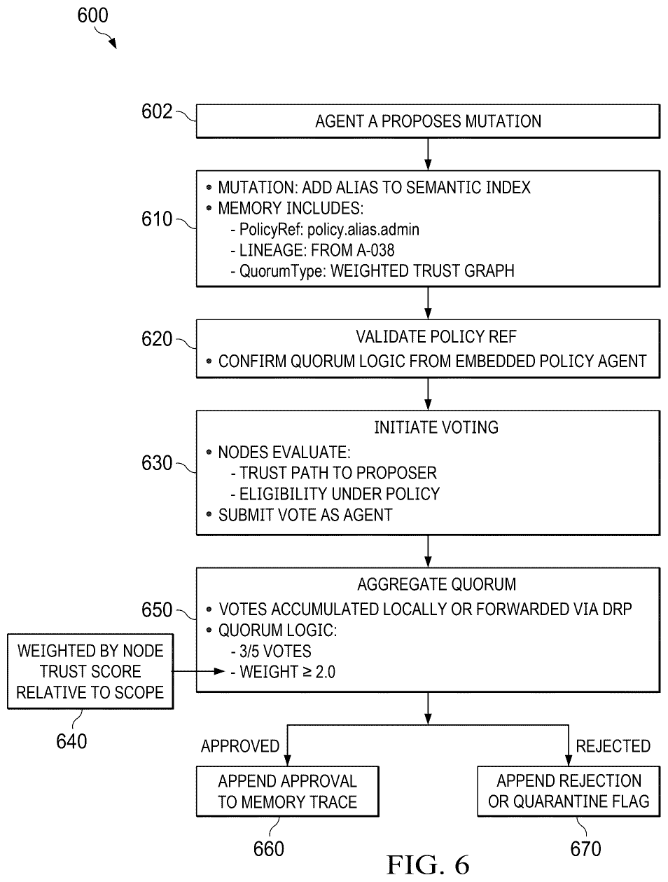

FIG. 6 provides an overview of an exemplary memory-driven consensus workflow 600. In this example, Agent A proposes a mutation to add an alias to a semantic index (610). The agent's memory field includes a policy reference (policy.alias.admin), a lineage pointer to its originating agent A-038, and a quorum type descriptor indicating a weighted trust graph.

Upon receiving the agent, the executing node validates the embedded policy reference using a local or cached policy agent (620) and confirms the quorum logic encoded in the memory field. If validation succeeds, the node initiates a scoped voting procedure (630) by evaluating two criteria: (1) the trust path to the proposer, and (2) eligibility under the referenced policy. Each vote is submitted as an agent bearing its own UID and trace and is weighted by the submitting node's trust score and domain scope (640). If validation fails—due to missing, expired, or unverifiable policy references—the node may reject the agent, quarantine it for manual review, or append a failure trace and return the agent to the proposer, depending on the node's local policy and dynamic routing precool (DRP) configuration.

Votes are accumulated locally or propagated via a dynamic routing protocol (DRP) to other quorum participants deemed eligible based on the criteria specified by the referenced policy agent—such criteria including trust path thresholds, semantic scope alignment, node role authorization, or prior participation history (650). The quorum logic embedded in memory specifies the voting threshold, such as a minimum of 3 out of 5 votes and a cumulative weight of at least 2.0. Upon quorum resolution, a success or failure flag is appended to the initiating agent's memory trace: approval results in an appended confirmation (660), while rejection triggers either a recorded denial or a semantic quarantine flag (670).

This process illustrates how memory fields not only document state, but also actively structure policy enforcement, voting behavior, and propagation eligibility so that they function as semantic substrates for cognition-native execution.

By making the memory field the authoritative source of trust, policy, and behavioral context, the present invention displaces the need for centralized control, out-of-band trust assignment, or hard coded protocol defaults. Each agent acts as a self-validating, self-constraining operand, whose execution is determined by what it carries, not where it came from.

### 4. Protocol Stack Architecture and Horizontal Execution Model

A horizontally composable protocol stack is designed to interpret and act upon agents based entirely on their internal structure and memory state. Unlike vertically integrated, centrally orchestrated network stacks, this architecture consists of protocol layers that operate in parallel, each consuming and acting upon data within the agent. These layers are designed to be modular, stateless or memory-aware, and capable of re-composition depending on deployment context. This enables the protocol stack to execute deterministically based on agent content without reliance on persistent infrastructure or node-local session storage.

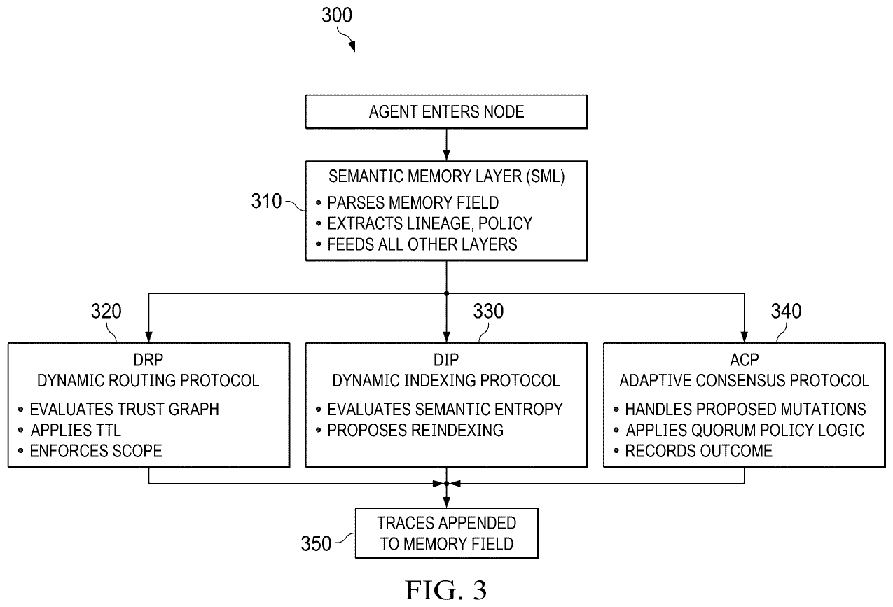

The protocol stack typically includes four layers: a dynamic routing protocol (DRP), a dynamic indexing protocol (DIP), an adaptive consensus protocol (ACP), and a semantic memory layer (SML). These layers may be implemented in whole or in part depending on node capabilities, trust configuration, and deployment topology. FIG. 3 provides a layered overview of a protocol stack process 300 and illustrates how incoming agents are processed concurrently across routing, indexing, and consensus layers based on the constraints and memory references embedded in each agent.

At the base of the stack, a semantic memory layer (310) interprets the memory field within each agent, extracting lineage, policy references, trust scores, and semantic tags. This layer enables every subsequent module to operate as memory-informed logic. It serves as the entry point to the semantic execution process, converting static data into active protocol operands.

A routing layer (320) uses this memory to inform path selection, trust scoring, and propagation scope. Unlike traditional routing tables or address-based forwarding, DRP routes based on an agent's embedded behavior, including access history and policy-aligned propagation boundaries. This allows for trust-scoped routing, localized adaptation, and memory-native suppression of unreliable paths.

An indexing layer (330) uses entropy thresholds and memory signals to determine whether an agent (or additionally index, if implemented using an adaptive network framework, such as those disclosed in U.S. patent application Ser. No. 19/326,036, titled “Adaptive Network Framework For Modular, Dynamic, and Decentralized Systems” filed Sep. 11, 2025, which is incorporated by reference for such disclosures) should be inserted, split, merged, or reclassified. This layer may be omitted in stateless deployments or implemented using DIP in environments integrated with the Adaptive Network Framework (ANF) or similar structural substrates.

A consensus layer (340) processes any mutation proposals encoded in the agent's memory field. If present, the agent triggers trust-weighted voting under an adaptive consensus protocol (ACP), wherein participating nodes evaluate the proposal using the policy agent linked in the memory field. This layer ensures that structural or behavioral mutation occurs only under scope-valid quorum conditions, even in the absence of external state persistence.

Each layer of the stack operates on agent-resident data and leaves a trace, which is appended to the agent's memory field upon execution (350). This trace is then used by downstream nodes to validate or replay execution outcomes, supporting trust continuity and semantic audit. This execution model enables protocol determinism and traceability, even across asynchronous or intermittently connected systems.

The result is a network substrate that is horizontally composable, memory-driven, and capable of enacting adaptive behavior directly from data structure. This protocol stack enables self-organizing, policy-bound behavior across a range of deployment scenarios—from cognition-aware AI systems to stateless edge networks—without requiring a monolithic governance layer.

### 5. Dynamic Routing Protocol (drp) and Trust-scope Message Flow

A dynamic routing protocol (DRP) is a memory-aware, behavior-sensitive routing layer that interprets agents and directs their transmission based not on static addresses or hop-count heuristics, but on trust scope, access history, policy constraints, and dynamic system health. DRP allows routing decisions to be made at each node without maintaining global routing tables, relying instead on the memory field embedded in each agent and local trust inference.

Upon receiving an agent, the node parses its transport header and memory field. The transport header specifies propagation constraints such as time-to-live (TTL), trust radius, and semantic class. These values determine the admissibility of the message at the current node and influence whether the agent is processed, forwarded, cached, or discarded. These constraints may be fixed or dynamically adjusted based on feedback from a network health monitoring system (NHMS), as described below.

The DRP evaluates not only network topology but also trust-weighted behavioral signals extracted from the agent's memory field and transport metadata. Each time an agent arrives at a new node, the DRP initiates a multi-stage evaluation procedure that parses the agent's transport header (250) and memory field (230), extracting access log entries, prior trace outcomes, and embedded policy references. The node begins by evaluating the access log, identifying the most recent execution history associated with neighboring nodes, including success rates, policy violation frequency, and node responsiveness.

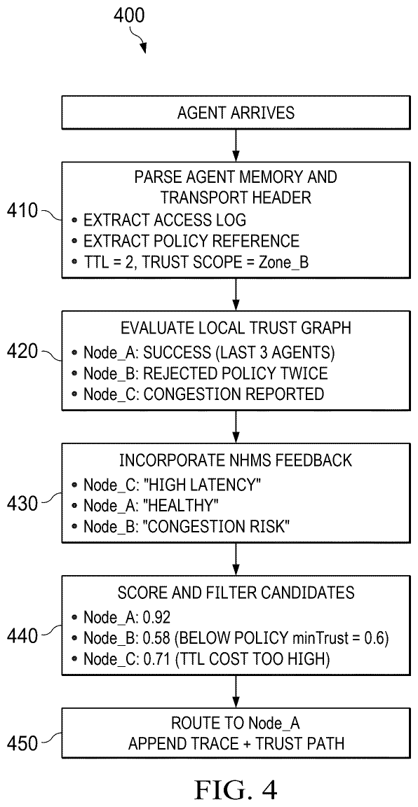

For example, in FIG. 4, an example of entropy-triggered semantic index restructuring 400 is outlined. In the case of an agent with a time-to-live (TTL) of 2 and scoped to Zone_B (425), as in 410, the DRP constructs a local trust graph (420) by referencing node-specific access records. Node_A is credited with successful execution of the last three agents, while Node_B is penalized for multiple policy rejections, and Node_C is flagged for congestion reports and prior delivery failures. The DRP optionally incorporates feedback from a network health monitoring system (NHMS, 430), layering in runtime signals such as high-latency alerts or congestion warnings. For instance, Node_C is reported as “high latency,” while Node_B is tagged with a “congestion risk” and Node_A remains in a “healthy”state.

The DRP next assigns dynamic trust scores to each routing candidate (440), integrating both historical access results and NHMS feedback. These scores are weighted against policy-defined thresholds—e.g., a minimum trust requirement of 0.60—and TTL costs. Node_A receives a score of 0.92 (450), Node_B scores 0.58 and is excluded due to falling below policy requirements, and Node_C receives 0.71 but is disqualified due to excessive TTL cost. The DRP selects Node_A as the optimal next-hop, appends the trust path to the agent's memory trace, and initiates forwarding (450).

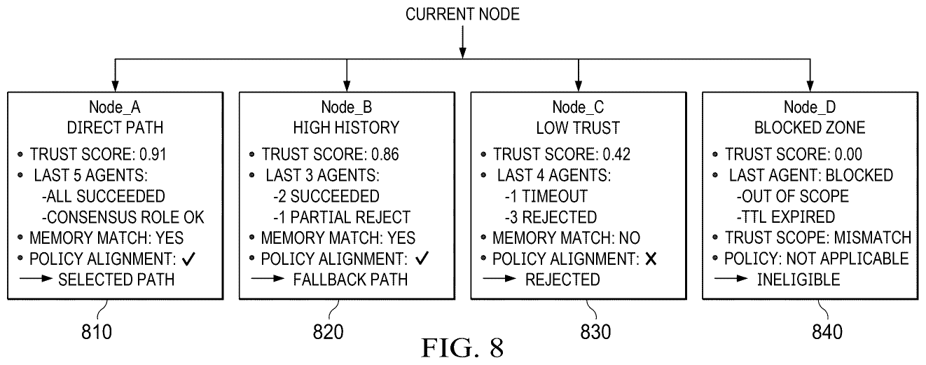

FIG. 8 provides an overview of agent routing among candidate nodes, in which selection is based on memory-derived trust scores and provides further elaboration on how DRP compares multiple candidates across a larger trust topology, integrating access history, semantic memory alignment, and policy conformance into the final routing decision. In the illustrated scenario, Node_A (810) is identified as a direct path with a high trust score of 0.91, and a success history across the last five agents, all of which fulfilled consensus or policy roles. Its memory profile is fully aligned with the agent's lineage, and it satisfies all active policy constraints, resulting in its selection.

Node_B (820) is treated as a fallback option. Although it holds a relatively high trust score of 0.86, its last three agents include one partial rejection. Memory alignment is acceptable, and policy compliance is not disqualifying, but it is deprioritized relative to Node_A. Node_C (830) is rejected due to a low trust score of 0.42, a track record of rejections and timeouts, and a memory mismatch with the agent. Node_D (840) is marked as ineligible, with a trust score of 0.00, TTL expiration, and a trust scope misalignment with the agent. DRP enforcement logic ensures that blocked zones and policy-incompatible nodes are categorically excluded from the routing graph.

Collectively, FIG. 4 and FIG. 8 provide an example of how DRP uses memory-anchored behavioral signals—not just static topology—to compute adaptive, trust-weighted transmission paths that align with the agent's semantic identity, transport metadata, and policy obligations.

Rather than executing fixed pathfinding logic, DRP operates as a distributed decision layer in which each node determines the optimal action for the agent based on a convergence of local policy, system conditions, and historical trust feedback. This enables the network to suppress unreliable or adversarial routes without requiring cryptographic exclusion, and to favor paths that exhibit compliance with behavioral norms defined in policy references embedded in the agent memory.

Agents may be marked as forwardable, suppressible, or urgent. These designations may be set initially at the agent's origin or updated by intermediate nodes based on feedback or propagation failure. Agents that exceed TTL, violate scope boundaries, or fail trust scoring are dropped or flagged for quarantine. These decisions and their justifications may be appended to the agent memory trace, enabling future routing or consensus layers to evaluate the cause and pattern of suppression.

The DRP layer also enables soft containment and semantic filtering at the edge. For example, in a knowledge network where certain zones enforce topic or jurisdictional boundaries, the DRP layer can prevent transmission of off-topic, stale, or mistrusted content from reaching core consensus nodes. This ensures that routing not only reflects connectivity and capacity, but also semantic alignment and governance scope.

The DRP transforms the network into a semantic transport layer governed not by addresses, but by behavior. It enables dynamic, decentralized message flow that reflects the agent's purpose, history, and trust profile—supporting policy enforcement and adaptive behavior at the substrate level.

### 6. Network Health Monitoring System (NHMS)

A Network Health Monitoring System (NHMS) is a protocol-layer service that enables memory-native nodes to evaluate, report, and respond to network conditions in real time. Rather than relying on out-of-band observability tools or external monitoring frameworks, the NHMS embeds operational signals into the same memory-native substrate that governs mutation, routing, and consensus. These signals are represented as agents—referred to as health agents—that propagate through the network and influence future routing and mutation behavior.

Each node running the NHMS module evaluates a variety of local metrics, which may include queue congestion, transmission failures, latency variance, semantic class entropy, quorum instability, and cache pressure. When thresholds are crossed, the node emits a signed health agent containing these observations. Health agents are routed using the same DRP logic described above, and may be selectively propagated depending on urgency, scope, and semantic alignment with recipient nodes.

A Node Health Monitoring System (Node HMS) operates as a distributed feedback mechanism through which nodes share health-state observations, congestion signals, and entropy divergence indicators. These observations are transmitted as dedicated health agents, which may be evaluated, accepted, or acted upon based on local policy and trust parameters.

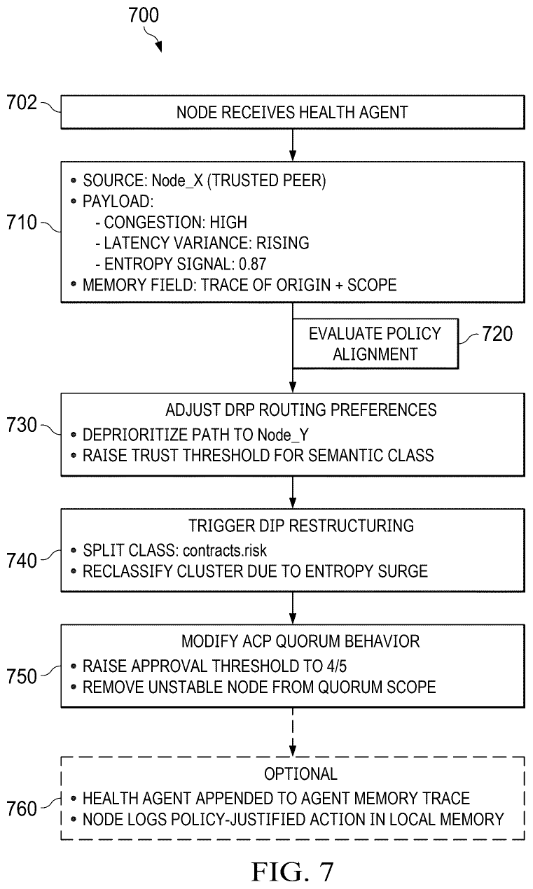

FIG. 7 illustrates an example of processing of an inbound health agent at a recipient node. Upon receipt, the node identifies the source of the report—e.g., Node_X, a recognized and trusted peer (710)—and parses the health payload, which includes reported congestion level, latency variance, and entropy signal values. In the illustrated case, Node_X signals high congestion, rising latency variability, and an entropy spike of 0.87. The incoming health agent also carries a memory field that includes the origin trace and trust scope of the report, allowing the recipient to assess whether the report is credible, scoped appropriately, and within actionable bounds.

The recipient node evaluates the health agent (720) against locally cached policies governing routing, indexing, and quorum configuration. If the report aligns with those policies, the node may take multiple actions. For example, it may update its DRP routing preferences (730), deprioritizing the path to a now-congested peer, such as Node_Y, and raise the trust threshold required for future transmissions within the affected semantic class (750).

At the indexing layer, the node may trigger structural reclassification in response to entropy divergence (740). In this scenario, the node invokes a dynamic indexing protocol (DIP) restructuring operation, splitting the semantic class contracts. risk into a new index cluster, based on the magnitude and locality of the entropy signal. This results in a re-indexing of related agents or sub-classes, enabling routing to a more semantically coherent or healthier cluster.

Optionally, at step 760 the recipient may append the health agent's data to the active agent's memory field, allowing downstream nodes to inherit health-state awareness as part of the agent's propagation. In all cases, the node also logs the policy-justified action to its local memory graph, preserving traceability and semantic accountability for the decision.

As shown in FIG. 7, a Node HMS creates a closed-loop feedback structure wherein nodes respond to health agents with local policy-bound adaptations to routing, consensus, and indexing—without reliance on centralized control or global synchronization.

A Node HMS also affects dynamic indexing protocols (DIPs) and adaptive consensus protocols (ACPs). In a DIP layer, entropy thresholds encoded in health agents may trigger index splitting, reclassification, or re-indexing decisions (as described below). In an ACP layer, health-derived trust volatility may influence voting eligibility or quorum thresholds, preventing unstable nodes from unilaterally affecting structural mutation events. An adaptive consensus protocol (ACP) may be dynamically adjusted. For example, the node may raise the required quorum threshold to 4 out of 5 participants or remove a previously trusted node from quorum eligibility due to health instability.

Health agents are semantic objects like any other, containing a payload, memory field, and signature. Their payload includes the observed metrics, encoded as structured data, and their memory field includes provenance metadata, propagation scope, and trace references.

A Node HMS transforms network adaptability from an administrative function to a protocol-native behavior. It enables decentralized reactivity to real-time conditions without central control, external dashboards, or global synchronization. The result is a substrate that can reroute, reorganize, or quarantine itself based on the lived experience of its own memory and the feedback of its neighbors—supporting cognition-compatible resilience and self-regulation.

### 7. Dynamic Indexing Protocol (DIP)

A dynamic indexing protocol (DIP) is an optional, pluggable indexing layer within the memory-native protocol stack. Its purpose is to provide structural organization of agents based on entropy, semantic class, and lineage density. DIP does not impose global containers or structural hierarchies, but rather operates as an adaptive, memory-informed indexing mechanism that enables local organization and reclassification of data flows in high-entropy or semantically fragmented environments, such as those described in U.S. Nonprovisional Ser. No. 19/326,036 , titled “Adaptive Network Framework for Modular, Dynamic, and Decentralized Systems,” filed Sep. 11, 2025 and incorporated by reference for such disclosure.

DIP governs structural adaptation of the semantic namespace in response to observed mutation patterns, access volatility, and memory-derived policy divergence. Each DIP-enabled node evaluates incoming agents to detect entropy thresholds, semantic divergence, or governance heterogeneity that would warrant local reclassification, trace merging, or index restructuring.

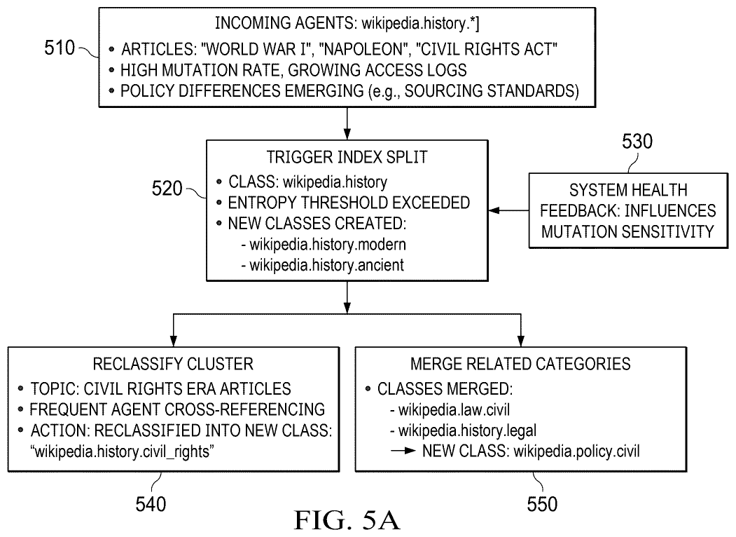

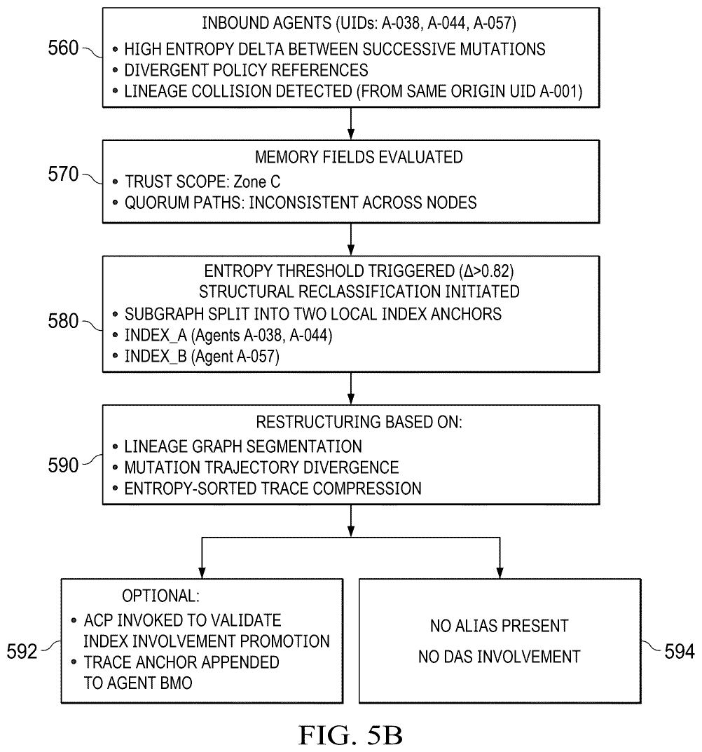

As illustrated in an example in FIG. 5A, a node receiving a sequence of agents classified under wikipedia. history.* (510)—including articles on “World War I”, “Napoleon”, and “Civil Rights Act” may detect elevated mutation frequency and rapidly expanding access logs. If this mutation density exceeds a predefined entropy threshold, the node initiates an index split operation (520), subdividing the original class into semantically distinct subcategories: e.g., wikipedia. history. modern and wikipedia. history. ancient. These class boundaries are derived from agent payloads, memory traces, and policy references, and may be enforced locally without global coordination.

Policy-driven divergence further informs index restructuring. For example, if agents in the original wikipedia. history class begin to include conflicting sourcing standards or governance metadata, DIP may split the class to reduce policy contention and promote quorum stability. System health signals emitted by local NHMS modules operating at individual nodes (530) may increase mutation sensitivity or lower the threshold for reclassification. These node-level signals, when propagated across the substrate, contribute to network-wide feedback loops that adapt DIP behavior in response to entropy surges or unstable semantic clustering.

In one scenario, a dense cluster of agents related to the Civil Rights era triggers a focused reclassification operation. The node detects frequent cross-referencing among agents tagged with civil_rights, along with sustained access volume and semantic coherence. As a result, DIP elevates the topic to its own index class: wikipedia.history.civil_rights (540), reducing cognitive and routing overhead for future queries within that domain.

DIP also supports trace merging, where semantically adjacent but administratively divergent classes are unified under a common parent index. For example, the node may detect sustained overlap between the classes wikipedia. law. civil and wikipedia.history.legal. Based on observed co-access patterns and shared mutation history, the node merges these classes into a new indexed category: wikipedia.policy.civil (550). All actions are triggered by local observations and justified by agent memory references and embedded policy constraints, without reliance on centralized indexing authorities.

As shown in FIG. 5A, DIP enables memory-native index restructuring as a semantic response to evolving class density, policy divergence, and entropy patterns—supporting dynamic knowledge management within decentralized execution environments.

As further illustrated in FIG. 5B, DIP also operates entirely within the substrate layer, independently of semantic aliasing or a DAS mapping. In this example, a node receives a sequence of agents identified only by UID—e.g., A-038, A-044, and A-057 (560)—each carrying memory traces that exhibit elevated entropy deltas between successive mutations, conflicting policy references, and a shared lineage origin from UID A-001. These agents lack semantic alias tags or external content identifiers.

The local DIP module evaluates the agents'memory fields, including their trust scope (Zone_C), lineage traces, and prior quorum paths (570). When the observed entropy divergence exceeds a configured threshold (e.g., Δ>0.82), the node initiates a structural reclassification event (580), segmenting the lineage graph into two local index anchors. Agents A-038 and A-044 are clustered into INDEX_A, while A-057 is placed into INDEX_B. This restructuring at 590 is based on lineage structure, mutation history, and entropy-detected semantic drift.

No alias resolution occurs, and no DAS is invoked as noted in step 594. The classification anchors are not persistent categories but are soft index points used to localize processing and improve routing behavior. If an ACP is enabled, the reindexing may optionally be validated at 592 through a scoped quorum. Whether or not ACP is invoked, the initiating node appends a trace anchor to the memory field of affected agents and logs the event in its local memory graph.

FIG. 5B illustrates an example of DIP's capacity to restructure semantic execution contexts purely on the basis of identity-native lineage and memory evolution, confirming that indexing logic can function independently of high-level class structures or human-readable taxonomies.

Each index formed by DIP is not a persistent structural container, but a soft-index anchor defined by statistical and policy-aligned behavior. Indexes may be ephemeral or replicated, depending on policy, quorum scope, or deployment objectives. Because DIP indexes are inferred rather than imposed, they enable dynamic structure formation without violating substrate flatness or stateless transport compatibility.

DIP relies on entropy calculations derived from semantic variation across agent payloads, policy divergence in memory fields, and access distribution in lineage logs. When these calculations exceed predefined tolerances, a DIP module generates an internal mutation proposal, scoped to the node's local trust domain. If an ACP is enabled, the reindexing event may be validated through quorum. If an ACP is not present, DIP operates in a fully autonomous, policy-constrained mode.

The interaction between a DIP and a DRP is particularly important in edge and asynchronous networks. DIP-based splits may be triggered not only by semantic overload but also by routing volatility or health signal propagation from node-resident NHMS modules. This ensures that semantic structure reflects network behavior and domain-specific load, not just data ontology.

Unlike the structurally enforced zones and path-indexed containers, a DIP within a memory-native substrate offers a local, feedback-responsive indexing layer that functions independently of a dynamic alias system (DAS), scoped policy anchors, or governance boundaries. This distinction allows a DIP to operate autonomously, or in tandem with an adaptive network framework (ANF), without duplicating its logic.

By making indexing optional, entropy-driven, and memory-governed, the DIP layer enables dynamic substrate behavior while preserving the core principle of data-native execution. It allows networks to restructure themselves based on actual semantic activity—without requiring pre-configured containers or rigid schemas.

### 8. Adaptive Consensus Protocol (ACP)

An Adaptive Consensus Protocol (ACP) is a memory-native mechanism that allows distributed nodes to evaluate mutation proposals carried by agents without relying on centralized coordination or globally synchronized state. Unlike traditional consensus mechanisms that require fixed validator sets or persistent governance registries, ACP dynamically scopes quorum eligibility based on policy references embedded within the agent's memory field. Each node evaluates its own eligibility, voting weight, and policy alignment autonomously, using only the information embedded in the agent.

As illustrated in the example outlined in FIG. 6, the consensus process 600 begins at step 602 when Agent A proposes a mutation—such as adding an alias to a semantic index—carried in its payload and described in its memory field (610). The memory field includes a policy reference (policy.alias.admin), a lineage trace from origin A-038, and an encoded quorum type indicating a weighted trust graph. These values collectively define the voting criteria and decision threshold required for the mutation to be accepted.

Upon receipt, the node verifies the agent's cryptographic signature—computed over the agent's UID, memory field, and payload using the sender's private key—and validates it against the sender's known public key. The node then parses the memory field and validates the embedded policy reference (620). The embedded policy agent specifies quorum logic, including eligibility roles, voting structure, and weighting parameters. Once validated, the node evaluates its own eligibility under the policy. If qualified, it initiates the voting process by assessing the trust path to the proposer and determining alignment with the embedded policy reference (630). Each vote is submitted as a new agent that includes a reference to the originating mutation, the voter's trust score, and justification metadata.

Votes are weighted relative to the node's domain scope and trust profile (640), then aggregated according to the quorum logic encoded in the agent's memory field (650). For example, a mutation may require a minimum of 3 out of 5 votes with cumulative weight ≥2.0 for approval. Votes may be accumulated locally or distributed via DRP to other eligible quorum participants.

If quorum is achieved, the ACP module appends an approval to the originating agent's memory trace (660), recording the vote outcome and embedding the quorum context for downstream auditability. If quorum fails or the proposal is rejected, a rejection or quarantine flag is appended instead at step 670. In either case, the memory field now encodes a complete execution trace of the consensus process, enabling future nodes to verify compliance with embedded policy and trust constraints.

ACP supports both stateless and memory-aware execution modes. In stateless mode, all eligibility, weighting, and decision logic are derived solely from the agent's memory field and system policy at runtime. In memory-aware deployments, nodes may reference prior mutation outcomes, trust scores, or policy participation history to inform quorum formation or trust weighting. This optional historical view enables reputation-aware quorum forecasting while preserving local autonomy.

ACP does not need to define persistent governance boundaries. It does not rely on external registrars, named zones, or alias hierarchies. Instead, consensus can be entirely scoped to the identity, memory, and mutation context of a single agent. FIG. 6 outlines how agents propagate trust-weighted votes, accumulate memory-rich approval traces, and trigger policy-governed mutation enforcement without centralized coordination.

An ACP enables verifiable mutation control across dynamic, trust-scoped environments without requiring global consensus or fixed role hierarchies. By making consensus a function of agent memory and policy embedding, the system achieves fine-grained governance resolution at the substrate level—allowing mutation enforcement to scale with data, not infrastructure.

### 9. Transport Compatibility and Stateless Deployment Modes

to the systems described herein can function as a memory-native protocol substrate regardless of the underlying network transport layer. This compatibility allows agents and the associated execution stack to be deployed over traditional transport protocols—including TCP/IP, HTTP, WebSockets, WebRTC, mesh relay, or delay-tolerant networking—without modification to the internal structure or behavioral semantics of the agent. The protocol stack described herein operates above the transport layer and interprets the agent as a complete operand, enabling stateless interoperability even in legacy or low-trust environments.

Each agent carries its own execution context, trust parameters, and routing constraints within the transport header and memory field. These internal references allow each node to evaluate the agent without reliance on persistent sessions, source-address-based routing, or transport-level state continuity. Once an agent is received and its signature is verified, the node parses its transport metadata and memory content to determine propagation behavior, routing score, mutation eligibility, and storage logic. Because no external session or registry is required, the protocol can be deployed in asynchronous or disconnected environments, including edge networks and interplanetary communication layers.

When operating over TCP/IP or HTTP, agents are typically serialized as structured data payloads, transmitted as-is, and deserialized at the receiving node. These agents maintain their structure and behavioral determinism independent of connection lifetime or transmission order.

Nodes may cache unresolved agents, reroute them via delay-tolerant protocols, or propagate them along broadcast overlays as needed. Regardless of how the agent arrives, the system treats it as a fully portable, self-contained behavioral unit.

The protocol also supports fallback execution in fully stateless environments. When nodes are configured without persistent memory, they rely exclusively on the embedded data within the agent for trust evaluation, quorum participation, and policy enforcement. This allows nodes with limited resources or transient uptime—such as IoT devices, ephemeral containers, or anonymized relays—to participate in substrate behavior without requiring full stack deployment or data retention. In such contexts, the agent remains authoritative and sufficient for secure execution.

This compatibility model enables the memory-native substrate to be integrated into existing infrastructure without requiring protocol replacement or disruptive reengineering. It also allows for dual-mode deployments where substrate-native nodes interoperate with legacy clients, enabling phased rollouts and hybrid system designs. Because behavior is embedded in the data—not imposed by the network—the system remains secure, predictable, and scalable across a wide variety of transport scenarios.

### 10. Interoperability With Cognition-native Protocols

The memory-native protocol substrate disclosed herein is interoperable with cognition-layer execution objects defined in related applications. While the substrate itself does not implement cognition or reasoning, it provides a deterministic, memory-governed execution environment that is compatible with cognition-native semantic agents. Specifically, semantic agents—data objects designed to carry intent, inference graphs, or cognitive execution plans—can be encoded and routed, mutated, or resolved using the same transport, memory, and consensus layers described herein.

An agent operating within this substrate may include an agent-specific semantic payload and may optionally use reserved or extended memory field sections to store cognitive lineage, reasoning context, mutation triggers, or belief-state deltas. These fields are interpreted by cognition-layer processors but remain structurally consistent with the agent model disclosed herein. The substrate stack, including DRP, DIP, and ACP, interprets these fields agnostically, acting only on memory-derived trust signals, transport metadata, and policy references, without needing to apply or simulate cognitive logic.

FIG. 3 and FIG. 6 illustrate how agents are treated as ordinary semantic objects by the execution stack. Each agent is parsed by the semantic memory layer, its routing constraints enforced by a DRP, and any mutation proposals processed by an ACP. In cognition-compatible deployments, these proposals may reflect internal agent reprogramming, goal updates, or subgraph mutations. However, the protocol stack does not require knowledge of the agent's internal model or execution semantics. It validates only that the mutation proposal satisfies quorum requirements, trust alignment, and structural constraints.

This architectural separation allows semantic systems to execute over the memory-native substrate while preserving protocol modularity and auditability. It also allows future cognition-layer systems—whether built on semantic execution or other agent frameworks—to operate atop the same substrate without requiring changes to the underlying routing, mutation, or consensus layers.

By embedding behavioral constraints, policy alignment, and mutation logic within the agent's memory field, agents executed over this substrate benefit from deterministic validation, trust-scoped propagation, and memory-aware audit—all without requiring external session management or predefined inference schemas.

This ensures interoperability between the cognition-native execution models described in related applications and the memory-native substrate protected here. It reinforces the role of the substrate as the foundational execution environment for cognition-native semantic agents, semantic systems, and trust-scoped coordination at scale.

### 11. Deployment Configurations and Integration Scenarios

The protocol stack and memory-native architecture disclosed are deployable across a wide range of network conditions, device capabilities, and governance models. The system supports both minimal deployments—where only routing and verification modules are present—and full-stack integrations that include memory retention, indexing, health monitoring, and consensus modules. Because the system is substrate-agnostic and behavior is defined by the agent itself, nodes may participate at varying levels of functionality without compromising the integrity or determinism of the overall execution environment.

In edge deployments, such as mobile devices, remote sensors, or IoT nodes, minimal substrate configurations allow these devices to receive and forward agents, evaluate routing and trust constraints, and optionally cache or discard data based on local policy. These deployments typically run a DRP and a simplified semantic memory layer—often configured in stateless mode to preserve resources, though minimal local memory structures may still be used to evaluate trust constraints or apply policy—while remaining fully interoperable with more complex peers.

In high-availability or core infrastructure nodes, the full protocol stack may be deployed, including a DIP for entropy-based indexing, an ACP for mutation consensus, and a locally executed NHMS module for real-time propagation of health signals. These nodes may also maintain memory graphs, participate in quorum formation, and evaluate structural reclassification triggers. They are well suited for use in knowledge systems, federated data exchanges, and high-volume cognitive networks.

In federated or cross-domain deployments, such as academic research networks or inter-organizational governance systems, the substrate can operate across administrative boundaries without requiring shared infrastructure or synchronized ledgers. Each domain may define its own policies and trust models, while the memory-native substrate enforces behavioral compliance using agent-carried rules and verifiable metadata. DRP and ACP modules operate independently per node, with consensus scoped locally and mutation eligibility enforced per policy reference.

The memory-bearing nature of agents allows the system to function in asynchronous, delay-tolerant conditions. Agents carry all necessary context for execution—policy, mutation proposal, quorum metadata, and routing constraints—allowing them to propagate and be validated even after long delays. This makes the substrate suitable for scenarios where intermittent connectivity, decentralized authority, or lack of centralized coordination are intrinsic constraints.

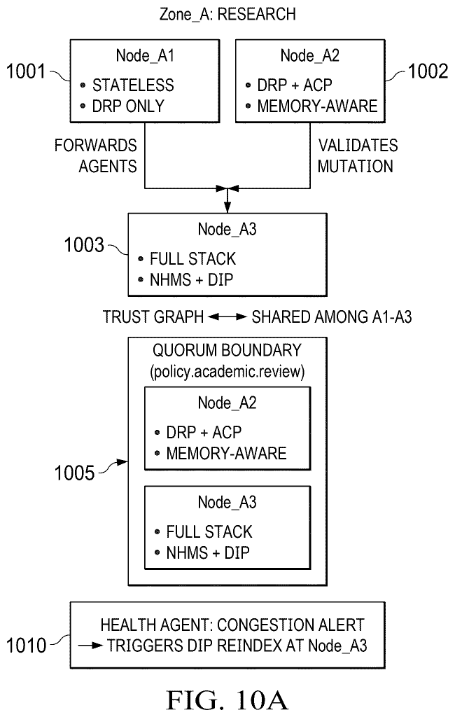

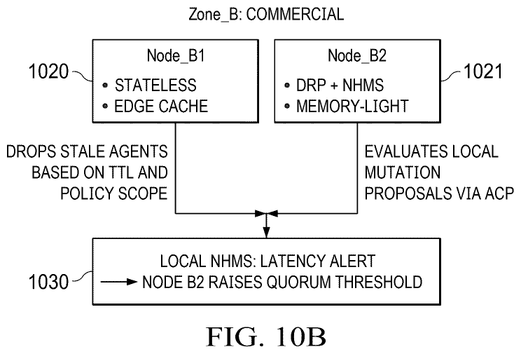

FIGS. 10A and 10B illustrate a federated semantic zone deployment in which nodes with heterogeneous stack capabilities participate in a shared trust graph and adaptive semantic propagation. The example demonstrates how stateless and memory-aware nodes coordinate policy-scoped mutation validation, congestion response, and health-triggered indexing within and across semantic zones.

In FIG. 10A, the deployment in Zone_A: RESEARCH includes three nodes—Node_A1 (1001), Node_A2 (1002), and Node_A3 (1003)—participating in a common trust graph and governed under the policy scope policy. academic. review in quorum boundary 1005. Node_A1 is stateless and implements only a DRP, forwarding agents based on routing scores and TTL parameters. Node_A2 operates in memory-aware mode with a DRP and an ACP enabled, allowing it to validate proposed mutations against embedded policy references and contribute to scoped quorums. Node_A3 runs the full protocol stack, including a DRP, a NHMS, and a DIP enabling it to act as an indexing authority within the zone. In the illustrated case, a congestion alert is received as a health agent emitted by an NHMS module operating on a peer node or embedded within a downstream agent's trace. This signal triggers a DIP reindexing event at Node_A3 (1010), resulting in dynamic restructuring of the local semantic graph.

In FIG. 10B, the deployment in Zone_B: COMMERCIAL includes Node_B1 (1020) and Node_B2 (1021), both of which are more lightweight. Node_B1 is a stateless edge node with local caching capabilities. It performs prefiltering by dropping stale agents based on TTL constraints and zone-specific policy bounds. Node_B2 is DRP-enabled and implements a NHMS with a memory-light footprint. Upon detecting a local NHMS latency alert (1030), Node_B2 raises its quorum threshold, increasing the mutation approval requirement for incoming agents in that class or scope. It may also evaluate and approve local mutations under a scoped ACP, based on embedded policy constraints.

Across both zones, the system demonstrates decentralized, trust-aligned coordination. Nodes adapt their behavior based on health signals, policy references, and memory-scope awareness without requiring centralized control or persistent trust registries. Together, FIGS. 10A and 10B provide an example of how the system allows for the federated behavior of memory-native substrates across trust domains with heterogeneous node capabilities.

This architecture supports evolutionary deployment models. Nodes may begin as stateless routers and progressively adopt more protocol layers as capacity or trust relationships deepen. Because behavior is driven by agent memory and transport metadata, no changes to node identity or coordination logic are required when adding capabilities. The protocol adapts seamlessly to the node's local context and the behavior of received agents.

By enabling layered, policy-bound, memory-informed execution across heterogeneous networks and device classes, a unified, cognition-compatible substrate deployable at global scale, local granularity, and across trust-divergent boundaries without sacrificing integrity, auditability, or runtime determinism can be supported.

### 12. Extension Pathways

A fully modular, memory-native substrate for distributed protocol execution, is capable of operating independently or as the foundational layer for cognition-compatible or structurally governed systems. By embedding state, policy references, mutation history, and access behavior directly into the data unit—defined as an agent—the substrate enables each object to govern its own propagation, mutation eligibility, and policy compliance without reliance on centralized control, global consensus, or externally maintained sessions.

This architecture supports stateless and memory-aware deployments, deterministic execution across legacy and modern transport layers, and fine-grained, policy-bound mutation governance at the data object level. With routing scoped by memory-derived trust models and behavioral feedback loops supported by a NHMS-generated health agents, the system can reorganize itself, suppress degraded routes, and prioritize aligned behavior—all while preserving structural clarity and auditability. It functions as a protocol execution environment in which semantic behavior emerges from the interaction between data structure and runtime memory, rather than being imposed through static roles or fixed hierarchies.

In addition to a protocol or a transport framework, the system defines a self-organizing, memory-informed execution substrate capable of supporting agents, networks, knowledge systems, and governance mechanisms that adapt, audit, and evolve without centralized control. Whether operating in isolation, in tandem with the ANF structural layer, or as the transport fabric for cognition-native semantic systems, the memory-native substrate disclosed herein establishes a deterministic foundation for distributed semantic computing.

### 18. Definitions

As used herein, “agent” refers to a cryptographically signed, memory-bearing data object that acts as the fundamental unit of transmission and execution within the disclosed substrate. Each agent includes a unique identifier, a payload, a memory field, a transport header, and a digital signature. These components collectively enable the agent to operate autonomously, carry state, and participate in routing, consensus, and indexing operations without reliance on external session state.

As used herein, a “semantic agent” is a specialized form of agent designed for cognition-native execution. In addition to the core components of an agent, a semantic agent may include an intent field, cognition-compatible payloads, and dynamic behavioral constraints. Semantic agents are capable of modifying their own structure or state in response to embedded policy references, memory context, or execution outcomes, enabling adaptive decision-making and fine-grained semantic control within distributed substrates. All semantic agents are agents, but not all agents are semantic agents.

As used herein, “memory field” denotes the section of an agent that records mutation lineage, access logs, trust evaluations, policy references, and optional execution traces. The memory field enables each agent to carry its behavioral history and governance context, allowing nodes to evaluate and act upon the agent deterministically without external session state.

As used herein, “transport header” describes metadata embedded in the agent that defines routing constraints, including time-to-live, trust radius, semantic class, latency sensitivity, and quorum priority. This header informs how an agent is forwarded, cached, or contained as it traverses the network.

As used herein, “dynamic routing protocol” or DRP is the memory-aware routing layer within the protocol stack that scores candidate paths based on trust information extracted from the memory field, network health signals, and semantic scope constraints. DRP replaces traditional address-based routing with trust-scoped propagation behavior.

As used herein, “dynamic indexing protocol” or DIP refers to an optional indexing layer that dynamically restructures semantic flows based on entropy thresholds, semantic density, and lineage volatility. DIP enables adaptive reclassification and semantic partitioning without requiring pre-configured hierarchical containers.

As used herein, “adaptive consensus protocol” or ACP describes a policy-referenced, memory-driven quorum mechanism through which nodes validate and authorize structural or behavioral mutations proposed by agents. ACP forms ad hoc voting quorums based on trust graphs and policy references embedded in the agent memory.

As used herein, “network health monitoring system” or NHMS means the subsystem by which nodes monitor local network conditions, generate health agents containing operational signals, and adapt routing, consensus, or caching behavior based on trust-scoped feedback.

As used herein, “health agent” refers to an agent emitted by NHMS that carries metrics such as congestion, trust volatility, propagation entropy, or cache pressure. Health agents influence future routing and mutation behavior by distributing real-time observations across the substrate.

As used herein, “trust graph” denotes the evolving, memory-informed model maintained by nodes, mapping prior interaction outcomes to trust scores used in routing and quorum weighting. Trust graphs may be ephemeral or persistently cached depending on deployment configuration.

As used herein, “mutation proposal” describes a structural or behavioral change request embedded within an agent, including reclassification, alias overrides, index splits, or policy updates. Mutation proposals are evaluated under an ACP using embedded policy references and scoped voting.

As used herein, “stateless mode” refers to a deployment configuration in which nodes do not persist external memory between agent evaluations. All routing, consensus, and propagation decisions are made exclusively using the data embedded within received agents.

As used herein, “memory-aware mode” describes a deployment configuration in which nodes maintain a persistent semantic memory graph, enabling enhanced trust modeling, quorum prediction, health feedback evaluation, and cache optimization based on accumulated historical context.

As used herein, “policy agent” refers to an agent that defines governance rules, mutation eligibility conditions, quorum thresholds, and role permissions for other agents. Policy agents are resolved via embedded references in the memory fields of proposing agents. A policy agent is a memory-bearing agent whose primary purpose is to encode governance logic, permission rules, and quorum constraints. Policy agents may be embedded within other agents or resolved via alias and are used to determine whether proposed mutations, access operations, or routing decisions meet the criteria required under the referenced policy. Policy agents do not typically mutate themselves but act as static or versioned authorities evaluated by other agents during execution.

As used herein, “access log” means the subcomponent of an agent's memory field recording prior interactions, including access attempts, mutation submissions, trust evaluations, and system feedback events.

As used herein, “trace entry” refers to a discrete event or decision recorded within the memory field of an agent as it traverses the network. Trace entries include routing outcomes, mutation results, health feedback responses, and policy evaluations.

As used herein, “cognition-compatible payload” denotes a semantic payload, such as a semantic agent, that encodes cognitive execution plans, inference graphs, or dynamic behavioral models capable of operating over the memory-native substrate without requiring substrate-level awareness of cognitive semantics.

As used herein, “federated semantic zones” describe collections of independently operated nodes or domains that coordinate routing, mutation, and indexing behavior across trust-divergent boundaries using shared memory-native substrate logic, without requiring centralized governance or global consensus.

As used herein, “entropy” refers to context-dependent, locally observable variation in semantic state, network conditions, and agent interaction history, used as a non-deterministic substrate for mutation proposal validation, proximity-aware routing, and adaptive cache orchestration. Unlike formal Shannon or thermodynamic entropy, entropy in this context denotes node-local uncertainty that emerges from ephemeral telemetry, resource pressure, lineage topology, and anchor-local mutation rates. It operates as a governing substrate for semantic object continuity, enabling the substrate to dynamically modulate execution flows, reweight agent trust, and adjust container scoping without centralized coordination. In the systems described herein, entropy supports persistence of memory-native agents by anchoring their routing and execution in temporally and topologically unique context windows.

As used herein, “near real-time” or “real time” describes a process that occurs or a system that operates to produce a given result with a slight but acceptable delay between the occurrence of an event, such as an acquisition of or update to relevant data, and when the given result is produced. In the context of the present disclosure, a slight but acceptable delay is in the range of about 250 milliseconds.

As used herein, a “consensus node” refers to a network node that is eligible to participate in, initiate, or validate quorum decisions under an Adaptive Consensus Protocol (ACP) based on information contained within the memory field of an agent. A consensus node may execute policy-referenced voting behavior, record trust-weighted votes, append consensus traces, and validate mutation eligibility according to embedded governance constraints. Eligibility as a consensus node is dynamic and scoped to the agent's transport header, policy references, and trust domain; it does not require persistent identity, fixed validator roles, or global registry.

“About” when used herein with reference to a value or range is used in its plain and ordinary sense as understood by persons of ordinary skill in the art as referring to standard tolerances for the referenced parameter, and when standard tolerances are not applicable, a value or range of values defined with “about” is met when a change in the range or value changes the changes the performance characteristics of the relevant parameter or the performance characteristics of the system as a whole by not more than five percent (5%).

The computer-based processing system and method described above may be implemented in any type of computer system or programming or processing environment, or in a computer program, alone or in conjunction with hardware. The present disclosure may also be implemented in software stored on a non-transitory computer-readable medium and executed as a computer program on a general purpose or special purpose computer. It is further contemplated that the present invention may be run on a stand-alone computer system, or may be run from a server computer system that can be accessed by a plurality of client computer systems interconnected over an intranet network, or that is accessible to clients over the Internet.

What is claimed is:

1. A computer-implemented system for memory-native protocol execution, comprising:
a plurality of agents, wherein each of the plurality of agents includes a unique identifier, a payload, a memory field, a transport header, and a cryptographic signature;
a plurality of distributed nodes, wherein each of the plurality of distributed nodes is configured to transmit and receive any of the plurality of agents; and
a modular protocol stack, wherein the modular protocol stack is configured to be executed at each of the plurality of distributed nodes, and wherein the modular protocol stack includes a routing layer, an indexing layer, and a consensus layer,
wherein behavior within the system of the routing layer, the indexing layer, and the consensus layer is determined by metadata embedded within a received respective one of the plurality of agents,
wherein the memory field of each of the plurality of agents includes verifiable lineage, access logs, and policy references, and wherein the verifiable lineage, the access logs, and the policy references include sets of instructions configured to govern routing, mutation, and consensus behavior for the corresponding one of the plurality of agents.

2. The system of claim 1, wherein each of the plurality of agents is configured to operate as a self-governing protocol operand, and wherein the transport header specifies constraints selected from the group consisting of: trust scope, time-to-live, semantic class, latency sensitivity, and quorum priority.

3. The system of claim 1, wherein each of the plurality of distributed nodes includes a local trust graph derived from prior memory field evaluations and is configured to dynamically score routing candidates during transmission based on the local trust graph.

4. The system of claim 1, wherein the protocol stack includes a network health monitoring system configured to emit health agents comprising congestion metrics, trust volatility, semantic entropy, and cache degradation data, and wherein each node is configured to modify routing or mutation behavior in response to received one or more health agents.

5. The system of claim 1, wherein the protocol stack is configured to be executed over a stateless transport layer selected from the group consisting of: TCP/IP, HTTP, mesh relay, delay-tolerant networking, and WebRTC.

6. The system of claim 4, wherein the one or more health agents include entropy thresholds configured to trigger index splitting or semantic reclassification by the indexing layer.

7. The system of claim 1, wherein the each of the plurality of agents comprises a cognition-compatible payload encoded as a data object, and wherein the protocol stack is configured to execute cognition-layer mutation behavior using memory field constraints and embedded policy.

8. The system of claim 3, wherein each of the plurality of distributed nodes is configured to adjust the local trust graph in response to trace outcomes embedded in received agents.

9. The system of claim 8, wherein each of the plurality of distributed nodes is further configured to update entries in the local trust graph based on data received from health agents emitted by a network health monitoring system and adjust node trust scores based on one or more observed metrics selected from a group consisting of congestion, latency variance, policy violation frequency, and propagation entropy, thereby allowing a dynamic routing protocol (DRP) to re-score candidate transmission paths in-real-time.

10. The system of claim 1, further including a dynamic indexing protocol (DIP) configured to form soft-index containers based solely on entropy anchors computed from agent-resident data, wherein the entropy anchors are statistical functions of mutation divergence trajectory, lineage density, and access-distribution patterns recorded in the memory field of the agent, and to create, split, merge, or promote local index anchors without involving or depending on a dynamic alias system or human-readable alias resolution.

11. The system of claim 1, further including a network health monitoring system is configured to emit health agents that, when received by one of the plurality of nodes, cause such node to execute one or more adjustments to parameters of an adaptive consensus protocol for one or more semantic classes, the adjustments including raising or lowering quorum thresholds, excusing or reinstating specific participations from quorum eligibility, and re-weighting participant votes.

12. The system of claim 1, wherein each of the plurality of agents is a semantic agent having a structure with an intent field and a cognition-compatible payload, and wherein the structure is configured to be modified in response to policy references or execution context stored in the memory field.

13. The system of claim 1, wherein each of the plurality of agents includes a reference to a policy agent, the policy agent comprising quorum rules, mutation eligibility criteria, and role definitions referred to when governing execution behavior.

14. A computer-implemented method for distributed memory-native communication, comprising:
receiving an agent at a node, the agent comprising a unique identifier, an access log, a payload, a memory field, a transport header, and a signature;
verifying the signature of the agent and parsing the transport header and the memory field;
determining routing eligibility and mutation scope of the agent by evaluating the access log and policy references of the agent;
executing one or more protocol stack layers based on content contained in the memory field;
appending a trace log to the memory field; and
forwarding, after appending the trace log, the agent to one or more eligible nodes,
wherein the one or more eligible nodes is determined by assessing dynamic routing protocol and one or more memory field constraints, for mutation execution or resolution.

15. The method of claim 14, wherein determining routing eligibility includes scoring candidate paths based on trust scores derived from access log outcomes recorded in prior agents.

16. The method of claim 14, further including triggering a consensus operation when the memory field indicates a proposed mutation, and evaluating trust-weighted votes cast by participating nodes cast according to a policy agent referenced in the memory field.

17. The method of claim 14, further including restricting and authorizing read, write, or mutation behavior based on policy references contained in the memory field without reliance on external session state.

18. The method of claim 14, wherein the agent is a semantic agent having a structure with an intent field and a cognition-compatible payload, further including modifying the structure in response to policy references or execution context stored in the memory field.

19. The method of claim 14, wherein the agent includes a reference to a policy agent, the policy agent including quorum rules, mutation eligibility criteria, and role definitions, further including governing execution behavior of the agent based on the quorum rules, mutation eligibility criteria, and role definitions.

20. The method of claim 14, wherein evaluating the access log includes identifying the most recent execution history associated with neighboring nodes, including success rates, policy violation frequency, and node responsiveness.
